(19) United States
(12) Patent Application Publication
(10) Pub. No.: US 2006/0172114 A1
(43) Pub. Date: Aug. 3, 2006

(54) Bench guard

(76) Inventor: Darras L J Hancock, Grandchester (AU)

Correspondence Address: LADAS & PARRY, 26 WEST 61ST STREET, NEW YORK, NY, 10023, US

(21) Appl. No.: 10/517,950

(22) PCT Filed: Nov. 11, 2002
(86) PCT No.: PCT/AU02/01529

§ 371 Date: Oct. 3, 2005

(30) Foreign Application Priority Data
Jun. 17, 2002 (AU) PS 2983
Oct. 23, 2002 (AU) 2002952207

(51) Int. Cl. B32B 7/00

(52) U.S. Cl. 428/119

(57) ABSTRACT

A demountable safety guard adapted for prevention of accidental urged dislodgment of an article or liquid over an edge of a fixed horizontal surface; said edge not otherwise precluding the dislodgement of said article.

The present invention relates to safety devices associated with working surfaces such as the tops of kitchen, work or laboratory benches and the like, and more particularly to means for the prevention of accidental dislodgement of objects or spillage of fluids from those working surfaces.

### BACKGROUND

For many people the lack of a suitable device to prevent the accidental spillage of materials or fluids and the accidental dislodgement of objects from benches, cooktops and tables, has resulted in serious injury and or expense and even, in extreme cases, to fatalities.

The accidental spillage of hot or caustic fluids (for example hot tea or coffee) from benches and tables in the kitchen is one of the leading causes of death and injury for young children in western civilizations. The elderly and infirm also suffer from such occurrences.

The accidental dislodgement of objects and the spillage of fluids from work benches and tables can impact on industry both financially and through injury to employees. School science benches are another area of potential risk if an object is accidentally dislodged or a fluid spilled; hot and caustic substances again being a leading cause of injury to school age children in the classroom.

It is an object of the present invention to offer an aid in the prevention of such incidents.

### BRIEF DESCRIPTION OF INVENTION

Accordingly, in one broad form of the invention, there is provided a demountable safety guard adapted for prevention of accidental urged dislodgment of an article or liquid over an edge of a fixed horizontal surface; said edge not otherwise precluding the dislodgement of said article.

Preferably said surface includes a bench top, a cooktop or a table top.

Preferably said guard comprises a substantially vertical elongate rectangular member having an outwardly facing surface and an inwardly facing surface bounded by edges, extending along at least a portion of an edge of said surface.

Preferably said edge is any edge of said surface from which said article can fall when urged to within sufficiently close proximity of said edge.

Preferably said guard is adapted to be inserted into a slot in said surface.

Preferably said slot is provided with a cover strip; said strip adapted to prevent the ingress of dirt and other matter into said slot.

Preferably said guard is adapted to be inserted into a guard retaining means attached to said surface.

Preferably said retaining means is in the form of an extruded channel, said channel adapted to be attached to said surface.

Preferably said extruded channel is attached to said surface by attachment means including one or more of:
a) an applied adhesive
b) a double sided adhesive tape
c) magnetic means
d) suction means
e) mechanical means including screws and rivets and the like.

Preferably said guard is attached to said surface by means of hinged elements.

Preferably said guard and said guard retaining means are formed of metallic materials.

Preferably said guard and said guard retaining means are formed of non-metallic materials.

Preferably said guard and said guard retaining means are formed of a combination of metallic and non-metallic materials.

Accordingly, in another broad form of the invention, there is provided a method for the prevention of the accidental urged dislodgement of an article or liquid over an edge of a fixed horizontal surface, said method including the provision of a guard member disposed along at least a portion of said edge of said surface, said guard member extending a sufficient height above said surface thereby defining a barrier to dislodgement of said article or liquid.

Accordingly, in yet another broad form of the invention, there is provided a method of providing a safety guard member for the edge of a fixed horizontal surface wherein said guard member is inserted into a slot disposed along said edge of said surface.

Accordingly, in yet another broad form of the invention, there is provided a method of providing a safety guard member for the edge of a fixed horizontal surface wherein said guard member is retained in an extruded channel fixed along an edge of said surface.

Accordingly, in yet another broad form of the invention, there is provided a method of providing a safety guard member for the edge of a fixed horizontal surface wherein said guard member is attached along an edge of said surface by hinge elements.

### BRIEF DESCRIPTION OF THE DRAWINGS

Embodiments of the present invention will now be described with reference to the accompanying drawings wherein:

FIG. 1 is a perspective view of a bench top safety feature according to a first embodiment of the invention.

FIG. 2 is a perspective view of an alternative retaining means of the embodiment of FIG. 1.

FIG. 3 is a perspective view of a bench top safety feature according to a second embodiment of the invention.

FIG. 4 is a perspective view of a component for use with the arrangement of any one of FIGS. 1, 2 or 3.

FIG. 5 is a perspective view of means of attachment of a component of the embodiment of FIG. 1.

FIG. 6 is a perspective view of the embodiment of FIG. 1 in use.

FIG. 7 is a perspective view of visual alignment of a child's eyes compared with adult eyes with and without use of embodiments of the present invention.

FIG. 8 is a perspective view of a bench guard in accordance with a further embodiment of the present invention.

FIG. 9 is a bench guard in accordance with a further embodiment of the present invention.

FIG. 10 is a bench guard in accordance with yet a further embodiment of the present invention.

### DETAILED DESCRIPTION OF PREFERRED EMBODIMENTS

Embodiments of the present invention provide for the addition of suitable guard elements to the periphery of working surfaces where the edges of those working surfaces are not otherwise protected, such as for example by splashbacks or abutting walls.

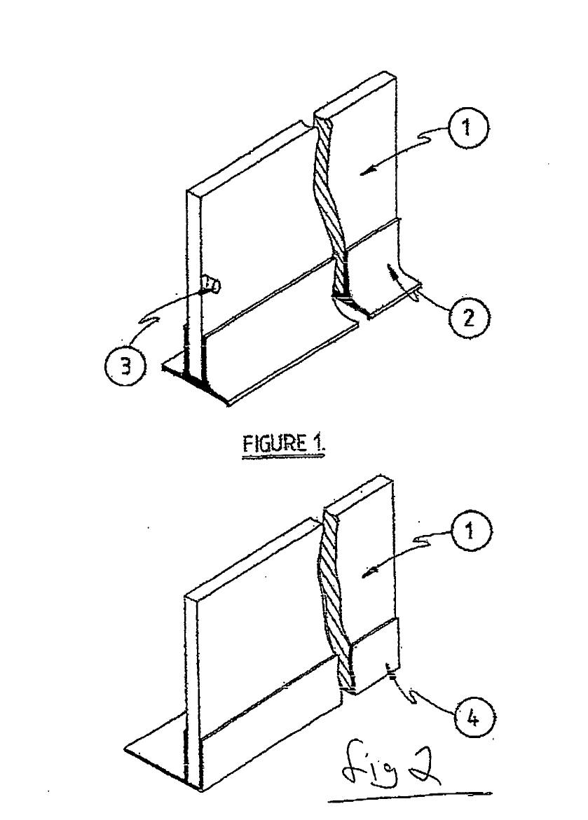

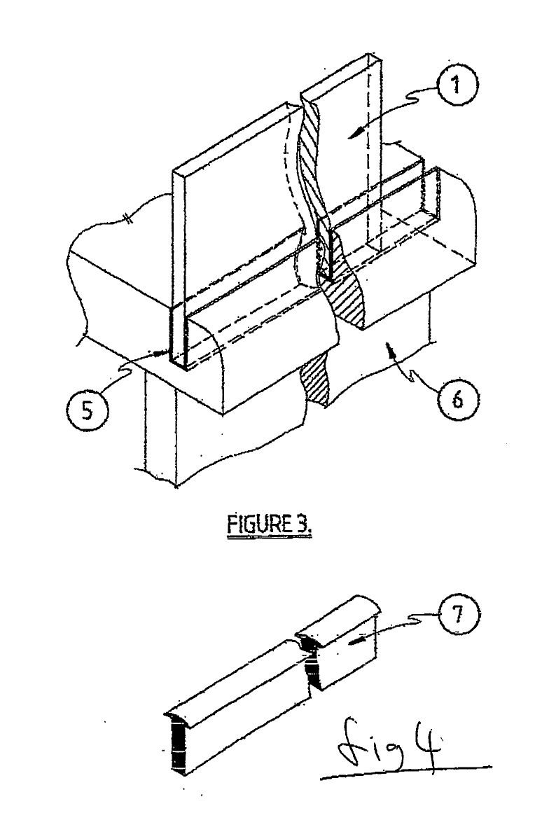

In a first preferred embodiment of the invention with reference to FIGS. 1 and 2, there is provided a vertically extending guard element 1 located in a retaining element 2 (or 4). Guard element 1 is in the form of an elongate rigid strip of suitable height and thickness extending along at least a portion of an exposed edge of a working surface as may best be seen in FIG. 6.

As may be seen in FIG. 5, in this first embodiment the guard element 1 is secured to the working surface of a bench top 6 by means of a retaining element 2 (or 4) in the form of an extruded channel section. Retaining element 2 (or 4) may be secured to the bench top 6 by a variety of means as shown in FIG. 6, for example by screws 9, rivets 10 or by means of two-sided self-adhesive strip 8. Further methods of holding the retaining element 2 (or 4) to the surface of bench top 6 may included bonding with suitable adhesives, or non-mechanical means such as magnetic strips or by suction means.

Guard element 1 may be fixed either permanently or releaseably or semi-permanently (for example by a friction fit or by a moulded locking fit) in retaining element 2 (or 4) or may be held in place as a friction fit so as to allow for its removal when the guard function is not required. Guard element 1 may optionally be provided with a hole 3 so as to allow for its storage at some convenient location by suspension from a hook (not shown).

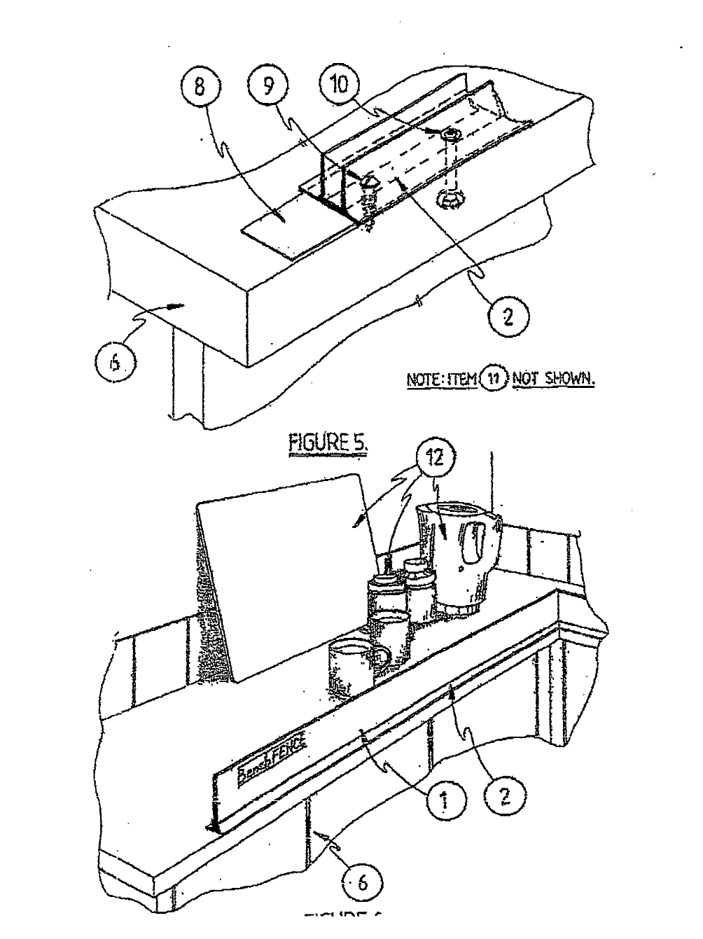

In a second preferred embodiment of the invention as shown in FIG. 3, guard element 1 is mounted in a slot 5 located along an edge of bench top 6. The slot may be formed by machining into the surface of the bench top or as part of an edging strip attached to the edge of the bench top.

In this embodiment also, guard element 1 may be permanently fixed either permanently or semi-permanently (for example by a friction fit or by a moulded locking fit) in slot 5 or alternatively may be located in the slot as a friction fit so as to be removable when desired. In this latter case slot 5 may be provided with a cover strip 7 (shown in FIG. 4) so as to prevent the ingress of material or liquids into slot 5 and as an aid to appearance.

In a further preferred embodiment of the invention, the slot may be covered by a spring-loaded cover strip which is urged into position over the slot as the guard element is removed.

In yet a further preferred embodiment of the invention, guard element 1 may be operatively attached to bench top 6 by means of hinges. The hinges may be permanently attached to the working surface of the bench top or alternatively could be demountable.

In all the embodiments described, the guard element may be formed from any of a range of suitable materials, including laminates of timber, pressed fibre or plastic or combinations thereof and metals such as steel or aluminium. Non-metallic materials may be transparent or opaque.

In use the guard element acts both to prevent liquids from flowing over the edge, or objects from accidentally being pushed over the edge of a bench top and as an impediment to small children reaching up to pull an object over the edge. In particular, a guard element arranged along the front of a cooktop located in the surface of a kitchen bench top will serve to minimize the possibility of this highly dangerous occurrence.

For embodiments of the invention in which the guard element is removable from the slot, different guard elements may be provided in a range of heights to suit different working and safety conditions. Thus for example in a laboratory situation where relatively tall vessels are in use, a relatively high guard can be inserted into the retaining element, whereas where the only concern is the spilling of liquids, a relatively low guard may be appropriate.

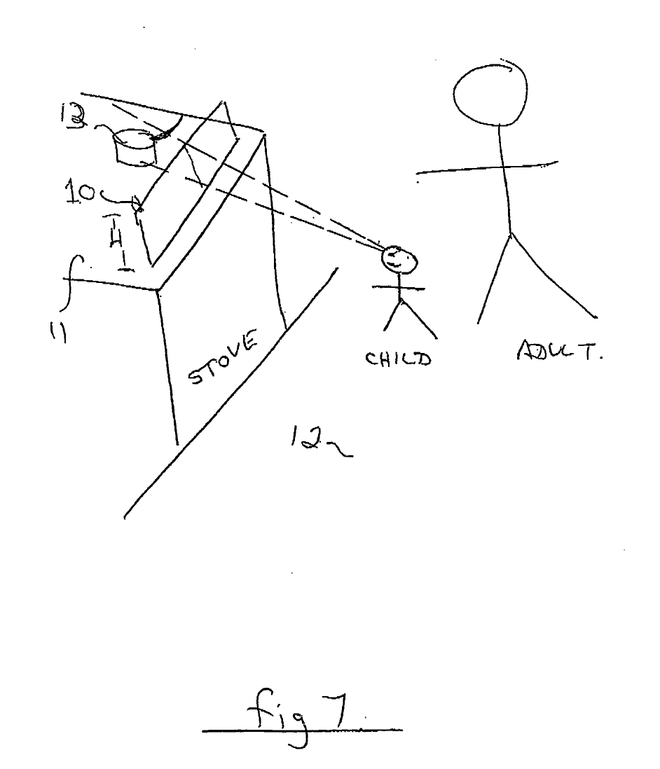

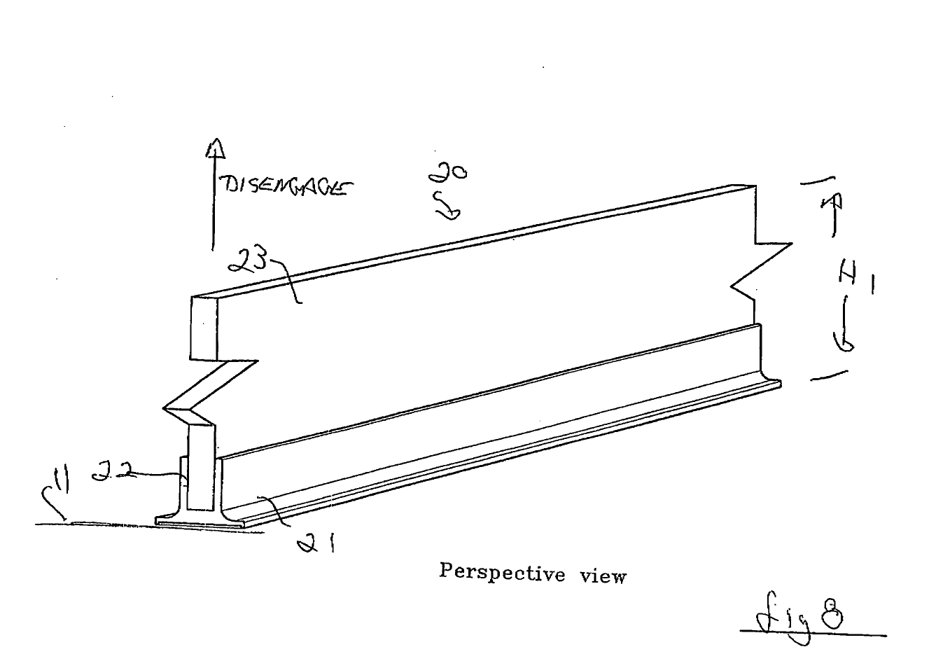

With reference to FIG. 7 a bench guard 10 in accordance with any of the previously described embodiments is illustrated in position on a stove or bench surface 11 and is arranged to have barrier height H selected such that when viewed from the eyes of a child at child head height on a floor 12 adjacent the bench or cooktop 11 the guard 10 acts as a visual barrier to the child seeing items beyond the barrier on the cook top or bench top 11. The barrier height H is further selected so that it is not so high that it impedes the sight line of an adult over the top of the guard 10. The end result is that the child is not able to see items on the other side of the guard whereby the child cannot become attracted to those items. Conversely the adult sight line is not impeded so that the adult may still operate effectively in a kitchen or like environment with the items such as saucepan 13 located on the stove or bench top 11.

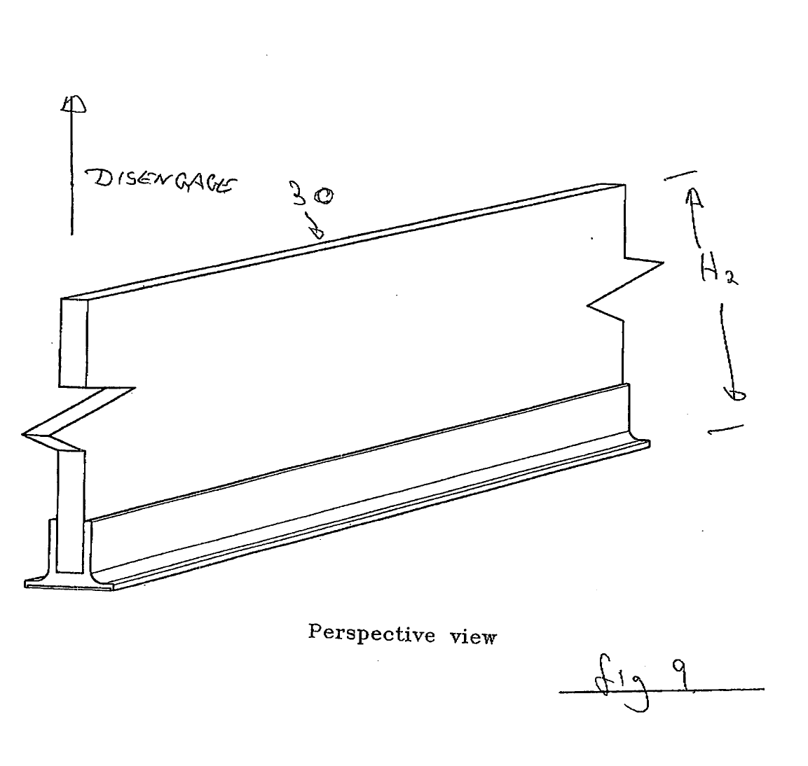

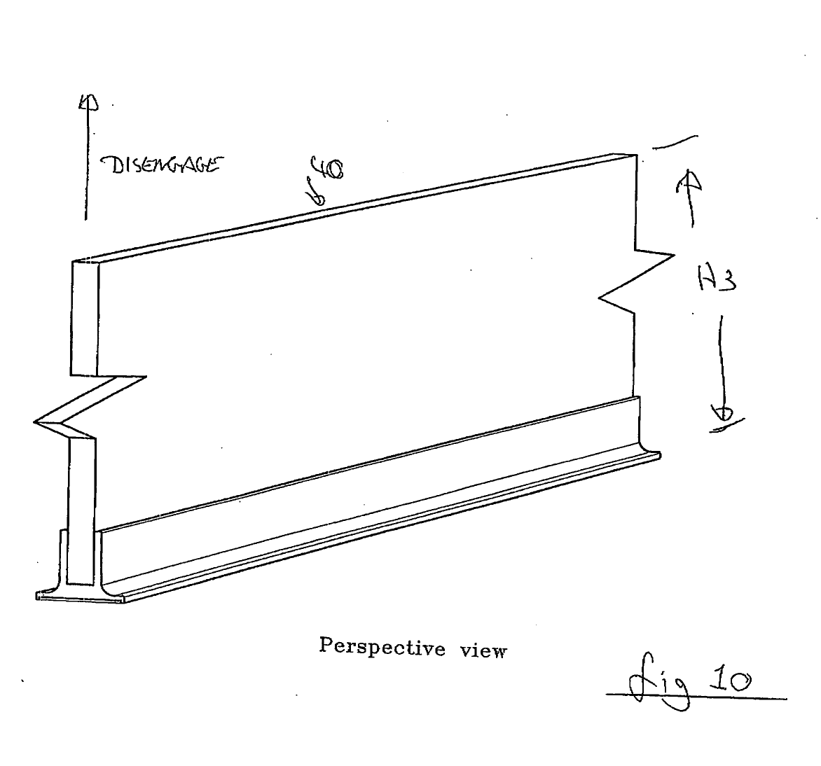

With reference to FIGS. 8, 9 and 10, three different embodiments of a guard comprising, respectively, guards 20, 30, 40 are illustrated in perspective view. Each guard is arranged to have a different height H above the surface of a bench top comprising heights H1, H2 and H3. Bearing in mind that the guard material itself is made from an opaque substance it is possible for a user to select from the various heights H1, H2, H3 so as to achieve the outcomes illustrated in FIG. 7 as between a child and an adult.

With further reference to FIG. 8 the guard 20 comprises a guard support rail 21 having a vertically aligned slot 22 therein which slidably receives in a vertical direction a substantially solid and contiguous guard member 23 therein and throughout the length of the slot 22.

As illustrated by the vertical arrow disengagement of the guard member 23 from slot 22 is accomplished by a vertical movement in an upward direction relative to rail 21. Conversely engagement is carried out in the reverse direction. The shape and relative angle of slot 22 as compared with bench top 11 is such that only substantially vertical engagement and disengagement movements are possible.

This arrangement ensures that the guard member 23 cannot be disengaged by a lateral pulling motion as might be expected by a child. On the other hand vertical disengagement is relatively easy for an adult for the purposes of cleaning and the like.

The above describes only some embodiments of the present invention and modifications, obvious to those skilled in the art, can be made thereto without departing from the scope and spirit of the present invention.

1. A demountable safety guard adapted for prevention of accidental urged dislodgment of an article or liquid over an edge of a fixed horizontal surface; said edge not otherwise precluding the dislodgement of said article.

2. The safety guard of claim 1, wherein said surface includes a bench top, a cooktop and a table top.

3. The safety guard of claim 2, wherein said guard comprises a substantially vertical elongate rectangular member having an outwardly facing surface and an inwardly facing surface bounded by edges, extending along at least a portion of an edge of said surface.

4. The safety guard of claim 3, wherein said edge is any edge of said surface from which said article can fall when urged to within sufficiently close proximity of said edge.

5. The safety guard of claim 1, wherein said guard is adapted to be inserted into a slot in said surface.

6. The safety guard of claim 5, wherein said slot is provided with a cover strip; said strip adapted to prevent the ingress of dirt and other matter into said slot.

7. The safety guard of claim 1 wherein said guard is adapted to be inserted into a guard retaining means attached to said surface.

8. The safety guard of claim 7, wherein said retaining means is in the form of an extruded channel, said channel adapted to be attached to said surface.

9. The safety guard of claim 8, wherein said extruded channel is attached to said surface by attachment means including
a. an applied adhesive
b. a double sided adhesive tape
c. magnetic means
d. suction means
e. mechanical means including screws and rivets and the like.

10. The safety guard of claim 4, wherein said guard is attached to said surface by means of hinged elements.

11. The safety guard of claim 1 wherein said guard and said guard retaining means are formed of metallic materials.

12. The safety guard of claim 1, wherein said guard and said guard retaining means are formed of non-metallic materials.

13. The safety guard of claim 1, wherein said guard and said guard retaining means are formed of a combination of metallic and non-metallic materials.

14. A method for the prevention of the accidental urged dislodgement of an article or liquid over an edge of a fixed horizontal surface, said method including the provision of a guard member disposed along at least a portion of said edge of said surface, said guard member extending a sufficient height above said surface thereby defining a barrier to dislodgement of said article or liquid.

15. A method of providing a safety guard member for the edge of a fixed horizontal surface wherein said guard member is inserted into a slot disposed along said edge of said surface.

16. A method of providing a safety guard member for the edge of a fixed horizontal surface wherein said guard member is retained in an extruded channel fixed along an edge of said surface.

17. A method of providing a safety guard member for the edge of a fixed horizontal surface wherein said guard member is attached along an edge of said surface by hinge elements.

18. (canceled)

19. A guard system for preventing accidental urged dislodgement of an article over a leading edge of a fixed horizontal surface; said guard arrangement comprising a rail adapted for alignment with reference to said edge and for affixing to said surface thereby to present a substantially vertically oriented slot for slidable engagement of a guard member therein; said guard member of substantially rectangular cross section in both longitudinal and lateral directions; said guard member adapted for substantially vertical engagement and disengagement with respect to said slot in said rail; said guard member substantially opaque throughout.

20. The guard member of claim 19, wherein the height of said guard member is selected so that said guard member acts as a visual barrier, when installed on said surface, to visualisation of objects on the far side of said guard member when viewed by a child but not by an adult.

21. A method of minimising accidental urged dislodgement of an article from a surface relative to an edge thereof; said method comprising providing the guard member of any one of claim 19 as a kit of two component parts.

22. The method of claim 21, wherein said two component parts comprise a rail having a slot therein and a substantially opaque guard member for vertical reception in said slot.

23. A guard device comprised of two and only two components.

24. The guard device of claim 23, wherein said two components comprise a guard member and a rail having a slot therein for vertical reception of said guard member therein.
